(19) United States
(12) Patent Application Publication
(10) Pub. No.: US 2004/0079472 A1
(43) Pub. Date: Apr. 29, 2004

(54) Method for manufacturing a drum and a drum for electrophotographic printing

(76) Inventors: Udo Drager, Speyer (DE); Detlef Schulze-Hagenest, Molfsee (DE)

Correspondence Address: Lawrence P. Kessler, Patent Department, NexPress Solutions LLC, 1447 St. Paul Street, Rochester, NY, 14653-7103, US

(21) Appl. No.: 10/360,043

(22) Filed: Feb. 7, 2003

(30) Foreign Application Priority Data
Mar. 22, 2002 (DE) 102 12 943.6

(51) Int. Cl. G03G 5/10; G03G 15/04; B65C 3/26; B29C 53/00

(52) U.S. Cl. 156/156; 430/69; 430/60; 430/127; 156/218

(57) ABSTRACT

A drum for electrophotographic printing, which is easy to assemble and economical and which provides reliable electrophotographic charging and discharging. A drum core is provided and an exchangeable sleeve is applied to the outside of the drum core, which contains a layer made of an elastic, fiber-reinforced, and conductive plastic. Furthermore, the drum contains a layer made of an elastic, fiber-reinforced, conductive plastic. Due to the conductivity of the elastic, fiber-reinforced, conductive plastic, the electrostatic charges can flow to or from an object, whereby electrostatic illustration is made possible. The sleeve has high stability and high elasticity due to the above-mentioned characteristics and it can be charged or discharged as desired. The sleeve can be easily mounted on the drum core due to its light weight and high elasticity.

### FIELD OF THE INVENTION

This invention relates in general to a drum for electrophotographic printing, and the method for the manufacturing of such drum.

### BACKGROUND OF THE INVENTION

Various drums of printers have coatings that are used for certain functions. For example, in electrophotographic printing, the image-displaying drum or illustration drum is coated with an organic photoconductor on which images are generated with powdery or liquid toner. The image is usually transferred directly from the illustration drum to the stock. However, some printers use an additional drum or intermediate drum, which takes the image from the illustration drum and transfers it to the stock. In this case, the images are displayed by illustration from the illustration drum by targeted electrostatic charging of the photoconductor layer and the adherence of toner to the electrostatic charges.

Because of the wear on the surfaces of the illustration drum and the intermediate drum, these are changed from time to time. However, the high-precision drum and the maintenance costs associating with the exchange are expensive. A known solution in U.S. Pat. No. 5,215,013 thus recommends exchangeable metal sleeves. The possible solution is, however, expensive and the application and removal of the sleeves is tedious and costly for the operator.

In the area of offset printing, the patent application WO 99/11468 is revealed with a printing component with a rubber blanket, which contains a printing layer made of rubber. Below the printing layer, there is a reinforcing layer made of rubber and underneath the latter, a compressible layer of rubber. The sleeve is tapered for easy assembly. The rubber blanket is applied to a sleeve that consists of a plastic reinforced with fiberglass. Between the rubber blanket and the sleeve, there is a primer layer for attaching the sleeve to the rubber blanket. The purpose of this configuration is to provide a smooth, seamless printing drum, which can only be used with certain printers as well as only with a rubber blanket drum.

### SUMMARY OF THE INVENTION

In view of the above, this invention is directed to a drum for electrophotographic printing that is easy to assemble as well as economical, and which permits reliable electrophotographic charging and discharging. The invention provides a method for manufacturing a drum for electrophotographic printing that provides a drum core and an exchangeable sleeve, which is applied to the exterior of the drum core, which contains a layer made of elastic, fiber-reinforced and conductive plastic. Furthermore, a drum for electrophotographic printing, made by this method is provided, in which includes a sleeve that contains a layer made of elastic, fiber-reinforced, conductive plastic. Due to the conductivity of the elastic, fiber-reinforced, conductive plastic, the electrostatic charging can flow to and from an object, which enables the electrostatic illustration. The sleeve has high stability and high elasticity due to the above-mentioned characteristics and it is economical due to its exchangeability and it can be easily charged and discharged as desired. The sleeve is easy to mount on the drum core due to its light weight and high elasticity.

The fiber-reinforced plastic for the layer is advantageously manufactured from an elastic, fiber-reinforced, conductive plastic by injecting a mixture made of resin and short-length fibers into a mold; the extrusion of the plastic with fiber lengths in the range of approximately 5 mm to 6 mm is particularly advantageous. In one embodiment of the invention, the layer is manufactured from an elastic, fiber-reinforced, conductive plastic that is translucent, which is applied to a photoconductive drum. Due to its advantageous space saving, the electrophotographic illustration of the sleeve with a layer made of an elastic, fiber-reinforced, conductive plastic can be performed within the interior.

In another variant of the invention, compressed air is supplied from within the sleeve, the diameter of the sleeve is expanded by the compressed air and the sleeve is removed from the drum core; another sleeve is subsequently applied to the drum core. The changing of the sleeve is thus considerably simplified.

With a custom-made embodiment, a drum core is provided with a sleeve for an illustration drum, whereby the sleeve made of elastic, fiber-reinforced, conductive plastic contains an electrode layer, a charge-generating layer to generate electrical charges, a charge-coupling layer to convey electrical charges, and with a further development, is configured with an optional abrasion layer to reduce the wear on the sleeve.

With another custom-made embodiment, a drum core with a sleeve for an intermediate drum is provided, whereby the sleeve contains a layer made of an elastic, fiber-reinforced, conductive plastic and another elastic, conductive layer.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 shows a schematic perspective section of a drum for electrophotographic printing with a drum core and an exchangeable sleeve; and

FIG. 2 shows a drum similar to the illustration according to FIG. 1 with an illustration device arranged in the drum.

### DETAILED DESCRIPTION OF THE INVENTION

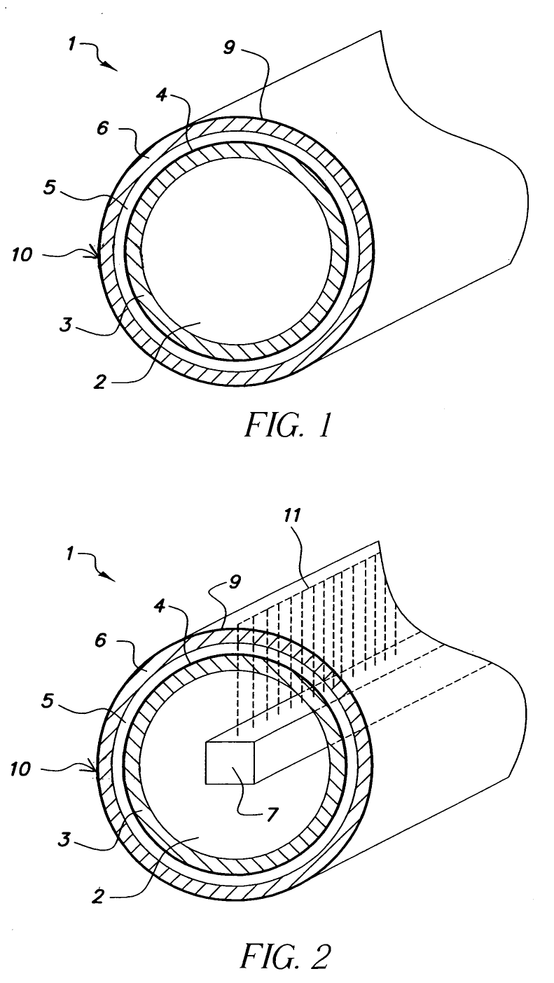

Referring now to the accompanying drawings, FIG. 1 shows a schematic perspective section through a drum 1. The drum 1 is for an electrophotographic printing process and is configured in particular as an illustration drum or an intermediate drum (not shown). The illustration drum is equipped with a custom-made embodiment of a sleeve 10, which includes one or two photoconducting layers for the purpose of the illustration, a charge-generating layer 5 and a charge-coupling layer 6 and an illustration device 7 located on the inside or outside of the illustration drum or imaging drum, which is loaded with latent images. For example, in FIG. 2, the illustration device 7 is illustrated within the illustration drum or the image-displaying drum. The intermediate drum is arranged next to the illustration drum, which takes the images from the illustration drum and transfers them to the stock. The intermediate drum has a sleeve 10 with an elastic, conductive layer with a thickness in the range of approximately 1 cm, which may be made of polyurethane, for example. In addition, a uniformly thin top layer can be applied, which facilitates the detachment of the toner during the transfer to the stock or paper and which reduces the wear on the intermediate drum.

The illustration drum and intermediate drum thus turn against each other and exert a certain pressure against each other. The intermediate drum is basically used to balance thickness variations in the stock, because the surface of the intermediate drum is more elastic than the surface of the illustration drum. The illustration is applied to the surface of the illustration drum by electrostatic charge. Following the application of the electrostatic charge on the sleeve 10, an image is selectively applied by the controlled illustration device 7, in which the photoconducting sleeve 10 is illuminated by pixels and a latent image emerges. Toner is subsequently applied to the latent image, whereby the toner particles of the potential difference between a device for applying toner, which contains the illustration device, and the illustration drum or imaging drum follow and an image to which toner has been applied emerges, which is transferred to another carrier.

In this example, the image to which toner has been applied is transferred from the illustration drum to the intermediate drum, which receives the image from the illustration drum and transfers it to a stock. The transfer of the image to which toner has been applied from the illustration drum to the intermediate drum and from the intermediate drum to the stock is supported by an electrical potential difference, whereby the transfer of the electrically charged toner particles is carried out by the electrical charging of opposite poles. In particular, for example, by using the positively charged toner, the negative charge on the surface of the intermediate drum is greater than the negative charge on the surface of the illustration drum, whereby positively charged toner particles on the surface of the illustration drum experience an action of force in the direction of the intermediate drum. A potential difference between the intermediate drum and the stock has a corresponding affect. When using negatively charged toner, opposite potential differences are used.

The sleeve 10, with a layer made of an elastic, fiber-reinforced conductive plastic 3, can be used with both the illustration drum and the intermediate drum; the drum 1 is therefore an illustration drum or an intermediate drum. With the application of the exchangeable sleeve 10 with a layer made of an elastic, fiber-reinforced conductive plastic 3 with an illustration drum, as illustrated in FIGS. 1 and 2, a drum core 2 is provided that is applied to the sleeve 10. In this embodiment used with an illustration drum, the sleeve 10 contains one or two photoconducting layers on the exterior, and beneath this, an optional electrode layer 4, made of, for example, vacuum-metallized aluminum (AL), nickel (Ni) or Chrome (Cr). The charge-generating layer 5 and the charge-coupling layer 6 generate or convey electrostatic charges; with the two-layered design, the charge generation and the charge coupling are each designed for one layer, as illustrated in the figures; in the one-layered design not shown, these are unified in one layer. The charge-generating layer 5 has a thickness in the range of approximately one or a few micrometers; the charge-coupling layer 6 has a thickness in the range of some ten micrometers.

In the direction of the drum core 2, the layer made of an elastic, fiber-reinforced, conductive plastic 3 is attached as described below. As an option and with a custom-made further development, a layer for facilitating the detachment of the toner and or preventing abrasion or an anti-abrasion layer 9 is further added to the sleeve 10. The anti-abrasion layer is optional and is not required for the drum 1 to fulfill its function. When using another custom-made embodiment (not shown) of the exchangeable sleeve 10 with an intermediate drum, a drum core 2 is provided, to which the sleeve 10 is applied, which contains an elastic, conductive layer with a thickness in the range of approximately 10⁻² m and underneath this, the layer made of an elastic, fiber-reinforced, conductive plastic 3. As an option, and as a custom-made further development, a layer for facilitating the detachment of the toner and/or preventing abrasion, or the anti-abrasion layer 9, is provided for the sleeve 10.

The intermediate drum is rolled off onto the stock and the toner is primarily transferred from the intermediate drum and to the stock by means of electrostatic forces. The sleeve 10 contains a conductive plastic; this exemplary embodiment contains a polyethylene polyamide plastic, also known by the brand name Nylon, or polyethylene polyamide. The conductive plastic is reinforced with fibers; in the present embodiment, an aramid fiber, polyparaphenylene terephthalamide is used, also known by its brand name Kevlar. The layer made of an elastic, fiber-reinforced, conductive plastic 3 of the exchangeable sleeve 10 is manufactured by extrusion, whereby a compound consisting of the conductive plastic and the fibers is provided, and the length of the fibers made from polyparaphenylene terephthalamide is, for example, approximately 5 mm to 6 mm. The specific resistance of the layer made of an elastic, fiber-reinforced, conductive plastic 3 of the sleeve 10 amounts to less than 10⁸ Ωcm.

Another manufacturing process of the layer made from an elastic, fiber-reinforced, conductive plastic 3 is described below. Polyparaphenylene terephthalamide fibers with a length of approximately 5 mm to 6 mm, which are diagonally woven together, are looped to a hose with an approximate diameter of the sleeve 10. In order to obtain a certain thickness of the layer made of an elastic, fiber-reinforced, conductive plastic 3, several hoses with marginally different diameters are manufactured and arranged on top of one another. The emerging hose is impregnated with an electrically conductive plastic, a thermoelastic resin, such as epoxy resin, and inserted in the mold, whereby the hose takes the shape of the mold. The impregnated fibers in the mold are subsequently heated and solidified and hardened by cooling. Instead of the thermoelastic resin, a compound made of elastic thermoplastics and reinforcing fibers can be used. In addition, an antistatic medium can be applied to the surface of the layer made of an elastic, fiber-reinforced, conductive plastic 3 or inserted therein or mixed with the conductive material during the manufacturing process.

Following the manufacturing of the layer made of an elastic, fiber-reinforced, conductive plastic 3, further layers are applied, depending upon whether the application is made with an illustration drum or a intermediate drum, in order to form the exchangeable sleeve 10, which is pulled onto the drum core 2. In this manner, a drum 1 is provided, which in FIG. 1 is an illustration drum, which, due to the exchangeability of the sleeve 10, can be used to save material and costs and which exerts uniform pressure, so that there are no seams or grooves on the surface, which are disadvantageous under pressure. The sleeve 10 achieves this characteristic in that the layer is made of an elastic, fiber-reinforced, conductive plastic 3, leaving no seams or grooves. The sleeve 10 is, on the one hand, sturdy, and on the other hand, elastic in such a way that the application of the sleeve 10 on the drum core 2 is easily accomplished.

The photoconductive characteristics of the drum 1, which in this case, is an illustration drum, are provided by the charge-generating layer 5 and the charge-coupling layer 6 of the sleeve 10. In one variant of the invention, compressed air is supplied from within the sleeve 10, the drum core 2 contains a suitable compressed air device for this purpose. The diameter of the sleeve 10 expands due to the compressed air; the sleeve 10 can now be simply removed from the drum core 2. After its removal, another sleeve 10 can be applied to the drum core 2. The changing of the sleeve is considerably simplified by using the compressed air device in combination with the elastic sleeve 10 based on the layer of an elastic, fiber-reinforced, conductive plastic 3. The remaining layers of the sleeve 10 are elastic in such a way that the increase in the diameter of the sleeve 10 is not impeded.

FIG. 2 shows a schematic perspective section of a view of a special variant of the invention, in which the sleeve 10 is as in FIG. 1 and is basically translucent. With this variant, the layer made of an elastic, fiber-reinforced, conductive plastic 3 of the sleeve 10 basically contains transparent plastic and fibers reinforced with fiberglass. The drum core 2 in the embodiment according to FIG. 2 is likewise basically composed of transparent material and allows the passage of light beams from the illustration device 7 basically without deflection. Many thermoplastics and thermoelastic resins have a low absorption of light in the visible spectral range and close to the infrared range and may be used. The illustration device 7 is firmly positioned, whereby the basically transparent drum core 2 with the basically transparent sleeve 10 has another position other than the illustration device 7, whereby the position of the drum core 2 with the sleeve 10 applied to the outside of the drum core 2 is permitted.

The illustration device 7 contains the required characteristics for the illumination of the photoconductive surface of the sleeve, basically a controlled light source. With the embodiment according to FIG. 2, the illustration device 7 runs along the axis of the drum 1 from one end to the other of the drum 1 and is designed with multiple beams, as illustrated in FIG. 2 schematically by means of the optical paths, represented by dashed lines, from the illustration device 7 to the surface of the exchangeable sleeve 10. The illustration device 7 can have any other designs, for example, a single-beam light source with a digital mirror device (DMD) or a multiple-beam light source with a light shutter.

The optical paths of the lights rays according to FIG. 2 run parallel to one another and cause an exposure of a line 11 of the photoconducting surface of the sleeve 10 at a time, whereby the line 11 of the photoconducting surface of the sleeve 10 runs axially to the drum 1, which is shown by the dashed lines. By rotating the drum 1, whereby the illustration device 7 is stationary, the drum core 2 and the sleeve 10 are moved in one direction. At a specific distance, that depends upon the resolution of the printer used and a specific print job, the next line 11 on the surface of the photoconducting sleeve 10 is exposed by the charge-generating layer 5 and the charge-coupling layer 6. The succession of the number of illustrated lines 11 results in the exposed latent image.

By the above-described drum 1 with the exchangeable sleeve 10 and the illustration device 7 within the drum 1, valuable space can be saved in a printer; the illustration device 7 is not applied to the outside the drum 1, as suggested in the-state-of the-art technology, whereby considerable space is in the printer. Similarly, a discharge lamp for discharging the electrostatic latent picture within the drum 1 is arranged, whereby the drum core 2 and the sleeve 10 are transparent. The discharging lamp is stationary and is used to eliminate electric charges on the surface of the photoconducting surface of the sleeve 10 after the application of the image to the stock, so that another uniform loading of electric charges can take place for the purpose of generating another latent image.

The invention has been described in detail with particular reference to certain preferred embodiments thereof, but it will be understood that variations and modifications can be effected within the spirit and scope of the invention.

What is claimed is:

1. Method to manufacture a drum (1) for electrophotographic printing, comprising: a drum core (2) is provided and an exchangeable sleeve (10) is applied to the outside of the drum core (2), which contains a layer made of elastic, fiber-reinforced, conductive plastic (3).

2. Method according to claim 1, wherein the layer made of fiber-reinforced plastic (3) is manufactured by injecting a compound of resin and short fibers in a mold.

3. Method according to claim 2, wherein the layer made of fiber-reinforced plastic (3) with the fiber lengths in the range of approximately 5 mm to 6 mm is extruded.

4. Method according to claim 2, wherein a hose is manufactured from the fibrous material, which has approximately the same diameter as the sleeve (10), in which the hose is inserted in a mold with a plastic, and the mold is heated at a predetermined temperature so as to heat the plastic, whereby a compound of the fibrous material and the plastic is produced, and the mold is cooled until the compound has solidified, and the compound is removed from the mold.

5. Method according to claim 4, wherein the sleeve (10) is manufactured so that it is translucent, which is applied to a photoconducting drum (1) and the sleeve (10) is illustrated electrophotographically on the inside of the sleeve (10).

6. Method according to claim 4, wherein the layer contains fibers that are knitted or woven from an elastic, fiber-reinforced, conductive plastic (3).

7. Method according to claim 2, wherein compressed air is supplied from inside the sleeve (10), that the diameter of the sleeve (10) is increased by the compressed air and the sleeve (10) is removed from the drum core (2) and another sleeve is applied to the drum core (2).

8. Drum (12) for electrophotographic printing, comprising a sleeve (10), which contains a layer made of an elastic, fiber-reinforced, conductive plastic (3).

9. Drum (1) for electrophotographic printing according to claim 8, further including a drum core (2) with a sleeve (10) for an illustration drum, said sleeve (10) containing a layer made of an elastic, fiber-reinforced, conductive plastic (3), an electrode layer (4), a charge-generating layer (5) to generate electric charges, and a charge-coupling layer (6) for conveying electric charges.

10. Drum (1) for electrophotographic printing according to claim 8, further including a drum core (2) with a sleeve (10) for an intermediate drum, said sleeve (10) containing a layer made of an elastic, fiber-reinforced, conductive plastic (3) and another elastic, conductive layer.

11. Drum (1) for electrophotographic printing according to claim 9, further including an anti-abrasion layer (9) is provided for the sleeve (10) to reduce the wear.

12. Drum (1) according to claim 8, wherein the plastic includes thermosetting resins, in particular those made of epoxy resin or polyester resin.

13. Drum (1) according to claim 8, wherein the plastic includes thermosetting plastics, in particular, polyethylene polyamides or polyethylene polyimides.

14. Drum (1) according to claim 8, wherein the fibrous material contains glass, carbon, silicon carbonate, aluminum fibers and/or polyparaphenylene therephthalamide.

15. Drum (1) according to claim 10, wherein to increase the strength of the layer made of an elastic, fiber-reinforced, conductive plastic (3), fibers with a length greater than 5 mm to 6 mm are used, which are woven at specific angles or diagonally to one another.

16. Drum (1) according to claim 8, wherein the specific resistance of the sleeve (10) is less than 10⁸ Ωcm.

17. Drum (1) according to claim 8, wherein the layer made of an elastic, fiber-reinforced, conductive plastic (3) is filled with carbon, graphite and/or metallic particles.

18. Drum (1) according to claim 8, wherein the sleeve (10) contains anti-static.
